(19) United States
(12) Patent Application Publication
(10) Pub. No.: US 2022/0174141 A1
(43) Pub. Date: Jun. 2, 2022

(54) TRANSFERRING, OBTAINING, STORING AND USING TELEPHONE NUMBERS

(71) Applicant: Vestel Elektronik Sanayi ve Ticaret A.S., Manisa (TR)

(72) Inventor: Sezgin HÍLAVÍN, Manisa (TR)

(21) Appl. No.: 17/434,694

(22) PCT Filed: Feb. 28, 2019
(86) PCT No.: PCT/EP2019/054992

§ 371 Date: Aug. 27, 2021

(51) Int. Cl. H04M 1/2757; H04L 9/40; H04L 9/08; G06F 21/62

(52) U.S. Cl. CPC H04M 1/2757; G06F 21/6254; H04L 9/0822; H04L 63/0435

(57) ABSTRACT

First telephone device creates a key for symmetric-key cryptography and encrypts the telephone number of the first telephone device using symmetric-key cryptography and the key. The key and the encrypted version of the telephone number of the first telephone device are transferred to a second telephone device. The second telephone device saves the key to memory and also saves to the memory at least one of (i) the encrypted version of the telephone number of the first telephone device and (ii) a decrypted plain text version of the telephone number of the first telephone device. The second telephone device is arranged such that a plain text version of the telephone number of the first telephone device is not displayed by the second telephone device.

### TECHNICAL FIELD

The present disclosure relates to methods of transferring, obtaining, storing and using telephone numbers, and computer programs therefor.

### BACKGROUND

It is common these days for a person to provide their telephone number to another person. However, the first person has practically no control over the use of their telephone number by the other person.

### SUMMARY

According to a first aspect disclosed herein, there is provided a method of transferring a telephone number of a first telephone device from the first telephone device to a second telephone device and storing the telephone number at the second telephone device, the method comprising:

at the first telephone device, creating a key for symmetric-key cryptography;

at the first telephone device, encrypting the telephone number of the first telephone device using symmetric-key cryptography and the key, thereby generating an encrypted version of the telephone number of the first telephone device;

transferring the key and the encrypted version of the telephone number of the first telephone device to the second telephone device;

at the second telephone device, saving the key to memory; and

at the second telephone device, saving to memory at least one of (i) the encrypted version of the telephone number of the first telephone device and (ii) a decrypted plain text version of the telephone number of the first telephone device obtained by decrypting the encrypted version of the telephone number using the key;

wherein the second telephone device is arranged such that a plain text version of the telephone number of the first telephone device is not displayed by the second telephone device.

In an example, the key and the encrypted version of the telephone number of the first telephone device are transferred to the second telephone device by the second telephone device reading a visual representation of the key and the encrypted version of the telephone number which is displayed by the first telephone device.

The visual representation may be for example a bar code or a QR (Quick Response) or some other two-dimensional code or the like.

In an example, the key and the encrypted version of the telephone number of the first telephone device are transferred to the second telephone device by the first telephone device wirelessly transmitting the key and the encrypted version of the telephone number to the second telephone device.

In an example, in the case that the second telephone device is used to call the first telephone device, the second telephone device:

retrieves the telephone number of the first telephone device from the memory of the second telephone device;

decrypts the telephone number of the first telephone device using the key if the telephone number of the first telephone device is saved as an encrypted version;

initiates an outgoing call to the first telephone device using the telephone number; and

displays on a display screen of the second telephone device an identifier of the first telephone device and an obfuscated version of the telephone number of the first telephone device.

Accordingly, the second telephone device can use the telephone number of the first telephone device to call the first telephone device but the second telephone device does not display a plain text version of the telephone number.

In an example, the method comprises transferring from the first telephone device to the second telephone device rules which define permitted use of the telephone number by the second telephone device, wherein the second telephone device saves the rules to memory and consults the rules and acts in accordance with the rules as necessary when a user of the second telephone device attempts to use the telephone number of the first telephone device.

According to a second aspect disclosed herein, there is provided a method of operating a first telephone device to enable transfer of a telephone number of the first telephone device from the first telephone device to a second telephone device, the method comprising:

creating a key for symmetric-key cryptography;

encrypting the telephone number of the first telephone device using symmetric-key cryptography and the key, thereby generating an encrypted version of the telephone number of the first telephone device; and

making the key and the encrypted version of the telephone number of the first telephone device available to the second telephone device.

In an example, the key and the encrypted version of the telephone number of the first telephone device are made available to the second telephone device by the first telephone device displaying a visual representation of the key and the encrypted version of the telephone number which can be read by the second telephone device.

In an example, the key and the encrypted version of the telephone number of the first telephone device are made available to the second telephone device by the first telephone device wirelessly transmitting the key and the encrypted version of the telephone number to the second telephone device.

In an example, the method comprises the first telephone device transferring to the second telephone device rules which define permitted use of the telephone number by the second telephone device.

According to a third aspect disclosed herein, there is provided a method of operating a second telephone device to obtain a telephone number of a first telephone device from the first telephone device, the method comprising:

receiving from the first telephone device an encrypted version of the telephone number of the first telephone device and an encryption key that was used by the first telephone device to encrypt the telephone number using symmetric-key cryptography;

saving the key to memory of the second telephone device; and

saving to memory of the second telephone device at least one of (i) the encrypted version of the telephone number of the first telephone device and (ii) a decrypted plain text version of the telephone number of the first telephone device obtained by decrypting the encrypted version of the telephone number using the key;

wherein the second telephone device is arranged such that a plain text version of the telephone number of the first telephone device is not displayed by the second telephone device.

In an example, the key and the encrypted version of the telephone number of the first telephone device are received from the first telephone device by the second telephone device reading a visual representation of the key and the encrypted version of the telephone number which is displayed by the first telephone device.

In an example, the key and the encrypted version of the telephone number of the first telephone device are received from the first telephone device by the first telephone device wirelessly transmitting the key and the encrypted version of the telephone number to the second telephone device.

In an example, in the case that the second telephone device is used to call the first telephone device, the second telephone device:

retrieves the telephone number of the first telephone device from the memory of the second telephone device;

decrypts the telephone number of the first telephone device using the key if the telephone number of the first telephone device is saved as an encrypted version;

initiates an outgoing call to the first telephone device using the telephone number; and

displays on a display screen of the second telephone device an identifier of the first telephone device and an obfuscated version of the telephone number of the first telephone device.

There may also be provided a telephone device constructed and arranged to carry out a method as described above.

There may also be provided a computer program comprising instructions such that when the computer program is executed on a telephone device, the telephone device is arranged to carry out a method as described above.

There may be provided a non-transitory computer-readable storage medium storing a computer program as described above.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of a telephone device;

FIG. 2 shows schematically an example of a method carried out on a first telephone device to enable its telephone number to be transferred to a second telephone device;

FIG. 3 shows schematically an example of a method carried out on a second telephone device to obtain a telephone number from a first telephone device;

FIG. 4 shows schematically an example of details of a first telephone device as displayed on a second telephone device; and

FIG. 5 shows schematically an example of a second telephone device using the number of a first telephone device to call the first telephone device.

### DETAILED DESCRIPTION

As mentioned, it is common these days for a person to provide their telephone number to another person. However, currently, the first person has practically no control over the use of their telephone number by the other person. With current arrangements, the other person, who typically will have saved the first person's telephone number on their own telephone device, can view that telephone number and pass it to third parties if they choose. The other person can typically also call the first person using the first person's telephone number at any time. In either case, the first person has no control over the use of their telephone number by the second person once the first person has given their telephone number to the second person.

In examples described herein, the first person's telephone device provides its telephone number via to the second person's telephone device in encrypted format. The first person's telephone device also provides a key that can be used by the second person's telephone device to decrypt the telephone number. The second person's telephone device is arranged so that it can use the first person's telephone device's telephone number, for example to make calls, send text or other messages, etc., but it never displays the first person's telephone number in plain text format and optionally cannot provide the first person's telephone number to another device other than in encrypted format.

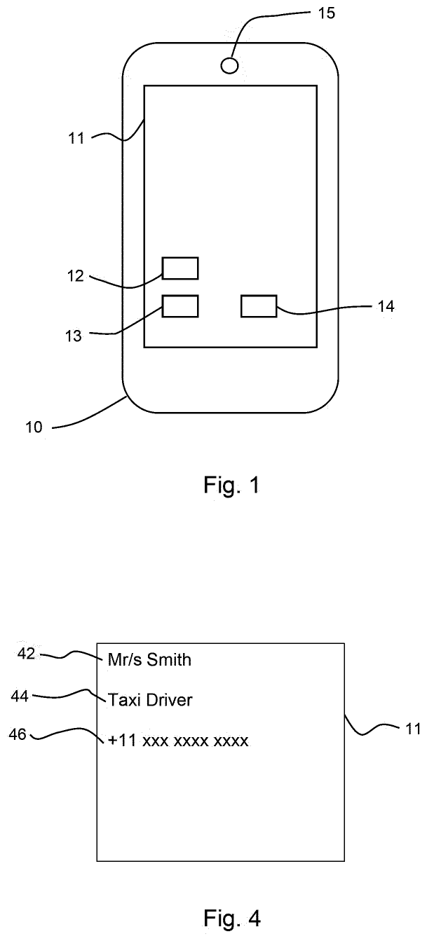

Referring first to FIG. 1, this shows schematically an example of a telephone device 10 according to the present disclosure. The telephone device 10 of this example is a smart phone, which also allows Internet access as well as enabling calls to be made. In other examples, the telephone device may be any other device that is able to make a telephone call, particularly a telephone call making use of a cellular network, and therefore may be a cellular phone generally, a general computing device, a tablet computer, etc.

The telephone device 10 of this example has a display screen 11. The display screen 11 may be a touch screen allowing touch inputs for various control functions and/or the telephone device 10 may have other, physical buttons or controls. The telephone device 10 has a processor 12 which runs software for overall control and specific functions of the telephone device 10, volatile memory 13 for temporary storage purposes, for example for use when the telephone device 10 is operating, and non-volatile memory 14 for permanent storage of data, software for the telephone device 10, etc. The telephone device 10 of this example also has a camera 15. The telephone device 10 also has the usual antenna (not shown) for wireless communications with a cellular network. The telephone device 10 may also have an antenna arrangement that provides for wireless transmissions in an ad hoc network with another device using for example at least one of Bluetooth and WiFi.

In the following and in the present specification generally:

the “first person” is a person who wishes to send their telephone number to another person. That is, the first person wishes to send the telephone number of the first person's telephone device 10′ or, more simply, the first telephone device 10′, to another person's telephone device;

the “second person” is a person who wishes to obtain the first person's telephone number. That is, the second person wishes to obtain the telephone number of the first telephone device 10′ and save it to their own, second telephone device 10″;

the “third person” is some third party, who may not be known to the first person.

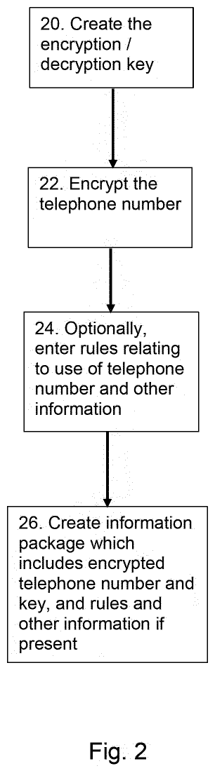

Referring to FIG. 2, when the first person wishes to send their telephone number to another person, the first person activates a specific, dedicated computer program or “app” on their telephone device 10′, which then operates and therefore causes the first telephone device 10′ to operate as follows.

First, at 20, the first telephone device 10′ creates a key which will be used to encrypt the first person's telephone number as stored on the first telephone device 10′. In this case, symmetric-key cryptography is used by the first telephone device 10′ to encrypt the first person's telephone number at 22.

A number of symmetric-key cryptography techniques and standards are known and may be used for this purpose, or some other symmetric-key cryptography technique may be used. Software for symmetric-key cryptography and for creating keys for symmetric-key cryptography is known and readily available. In symmetric-key cryptography, both the sender and the receiver use the same key for encryption and decryption respectively. (Sometimes, the encryption key and the decryption key in symmetric-key cryptography are different, but are related to each other in an easily computable way. For present purposes, for simplicity and by convention, these will nevertheless be regarded as the same key.) The key in effect is a shared secret which is shared by the first telephone device 10′ and the second telephone device 10″. Symmetric key ciphers as used in symmetric-key cryptography are typically implemented as either block ciphers or stream ciphers. A block cipher encrypts the input in blocks of plain text. A stream cipher encrypts the input as individual characters or digits (typically bytes) one at a time. Symmetric-key cryptography can be a fast process, especially if implemented in hardware, and is therefore particularly suitable for electronic devices that have a relatively low processing power.

Returning to FIG. 2, at 24 the first person may enter into their telephone device 10′ rules which govern or control how the second telephone device 10″ can use the telephone number of the first telephone device 10′. These rules may have been entered previously by the first person or may be entered at the time when the first person wishes to send the telephone number of the first telephone device 10′ to the second telephone device 10″. Moreover, the rules may be the same whenever the first person transfers their telephone number to another device or different rules may be entered and transferred when the first person transfers their telephone number to different devices. That is, there may be a common set of rules that apply for all other people to whom the telephone number is transferred or there may be different, bespoke rules for some or all of the other people to whom the telephone number is transferred.

Such rules may specify for example certain days or times of day when the second telephone device 10″ is or is not permitted to call the first telephone device 10′ (such as no calls during work hours or no calls at weekends, etc.). Such rules may specify for example that the second telephone device 10″ is not permitted to call the first telephone device 10′ and/or otherwise use the telephone number of the first telephone device 10′ after a certain number of hours, days, etc. has passed since the second telephone device 10″ obtained the telephone number of the first telephone device 10′. That is, in effect, an expiry date for the use of the telephone number of the first telephone device 10′ by the second telephone device 10″ may be set. Such rules may specify for example that the second telephone device 10″ is not permitted to send the telephone number of the first telephone device 10′ to any other device.

In addition, at 24 the first person may enter into their telephone device 10′ other information, which typically relates to the first person or the first telephone device 10′. Again, this information may have been entered previously by the first person. As will be explained further below, the intention is that this other information will be or can be displayed by the second telephone device 10″ so that the second person can locate and identify the required details of the first person on the second telephone device 10″. Such other information may be some identifier of the first person, such as their name (e.g. “John” or “Joanne Smith”), their role or job (e.g. “taxi driver”), etc.

At 26, the first telephone device 10′ creates an information package which contains at least the encrypted telephone number of first telephone device 10′ and the key and which will be transferred to the second telephone device 10″. Again, it is mentioned that, in symmetric-key cryptography, the key that is transferred may be the key that was used for the encryption and that can be used by the second telephone device 10″ for the decryption, or may be a mathematically related key that can be used by the second telephone device 10″ for the decryption. As another alternative, the key that is transferred may be the key that was used for the encryption and the second telephone device 10″ calculates the mathematically related key that is to be used by the second telephone device 10″ for the decryption. Again for simplicity and by convention, this is simply described herein as the key being transferred. The information package may also include any rules for use of the telephone number by the second telephone device 10″ and any other information which have been defined or entered by the first person on the first telephone device 10′.

A recognised concern with symmetric-key cryptography is that it requires the key to be transferred from the sender to the recipient and, as the key should be kept secret, that this is done securely. A number of ways of transferring the key from the first telephone device 10′ to the second telephone device 10″ are possible.

As a first example, the first telephone device 10′ may present the information package visually on the display screen 11 of the first telephone device 10′. The user of the second telephone device 10″ can position the second telephone device 10″ to be close to the first telephone device 10′ so that the camera 15 of the second telephone device 10″ can view the information package as displayed on the display screen 11 of the first telephone device 10′. The image viewed by the camera 15 of the second telephone device 10″ is then processed by the second telephone device 10″ to extract the data. As particular examples, the information package may be displayed on the display screen 11 of the first telephone device 10′ in the form of a bar code or a QR (Quick Response) or some other two-dimensional code, or the like. An advantage of transferring the information package by the second telephone device 10″ viewing a visual representation of the information package on the first telephone device 10′ is that the second telephone device 10″ has to be physically close to the first telephone device 10′. This means that the first person has better control of who and which devices can “see” the information package and helps to minimise the risk of some third party “snooping” or reading the information package using some unauthorised device.

As a second example, the first telephone device 10′ may present the information package by wirelessly transmitting the information package for receipt by the second telephone device 10″. For this, WiFi or Bluetooth or some other radio communication may be used. Again for security purposes, the wireless transmission technique which is used preferably requires the first telephone device 10′ and the second telephone device 10″ to be paired with each other using a password or the like. This may be via a direct communication between the two devices 10′, 10″ with password control, as can be set using for example Bluetooth, or via a third device to which both devices 10′, 10″ connect using a password or the like, such as for example a WiFi router or the like.

In any event, the second person activates a specific, dedicated computer program or “app” on their telephone device 10″, which then operates and therefore causes the second telephone device 10″ to operate as follows.

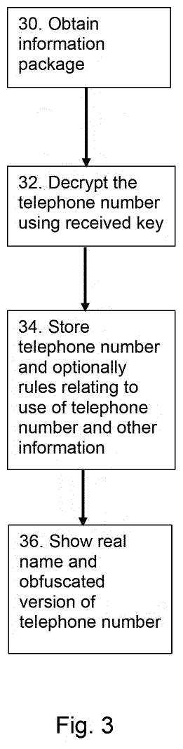

Referring now to FIG. 3, at 30, the second telephone device 10″ obtains from the first telephone device 10′ the information package which contains the key and the encrypted telephone number of the first telephone device 10′, and any rules and other information if also present in the information package.

At 32, the second telephone device 10″ decrypts the encrypted telephone number of the first telephone device 10′ using the key (which may be the identical key that was used for decryption or the related key if a different but related key is used for the decryption). This decryption may take place as soon as the second telephone device 10″ obtains the encrypted telephone number and the key or may take place later when the telephone number actually needs to be used.

At 34, the second telephone device 10″ saves the telephone number of the first telephone device 10′ and any related rules and other information to non-volatile memory 14 of the second telephone device 10″. The telephone number may be saved in decrypted, plain text form on the second telephone device 10″. If the telephone number if saved in plain text form on the second telephone device 10″ then some “flag” or the like may be set against that telephone number or the first person generally so that the second telephone device 10″ knows that the telephone number should not be displayed in plain text form by the second telephone device 10″. Alternatively, the telephone number may be saved in the encrypted form in which it was obtained. In that case, the key may also be saved to the non-volatile memory 14 at the same time so that the telephone number can be decrypted as and when needed by the second telephone device 10″. For better security, it is preferred that the telephone number is saved in encrypted form on the second telephone device 10″. A “flag” or the like may be set against that encrypted telephone number or the first person generally so that the second telephone device 10″ knows that the telephone number has been saved in encrypted form.

At 36, the second telephone device 10″ displays details of the first telephone device 10′. This may be done as part of a “phone book” or “contacts” function of the second telephone device 10″. At least some of these details may be derived from information entered by the first person into the first telephone device 10′ and transferred to the second telephone device 10″ in the information package. Alternatively or additionally, at least some of these details may have been entered manually by the second user into the second telephone device 10″. The second telephone device 10″ may display details of the first telephone device 10′ as soon as they are obtained and saved to the second telephone device 10″ and/or later, for example when the second user is browsing their list of contacts, is about to make a call or send a message, etc., to the first telephone device 10′.

Referring to FIG. 4, this shows an example of display of details of the first telephone device 10′ on the display screen 11 of the second telephone device 10″. In this example, the name 42 of the first person (e.g. Mr or Ms Smith) and their role/job 44 (e.g. taxi driver) are displayed in plain text. However, the corresponding telephone number, here the telephone number of the first telephone device 10′, is not displayed in plain text. Instead, the telephone number 46 is obfuscated somehow. A number of options for this are available. For example, as indicated, the first few digits may be shown in plain text (so that the second user can know that it is at least approximately the correct or an appropriate telephone number) whereas other digits are replaced with x's or asterisks or other characters. As another example, all digits are replaced with x's or asterisks or other characters. As another example, the encrypted form of the telephone number as obtained from the first telephone device 10′ may be displayed.

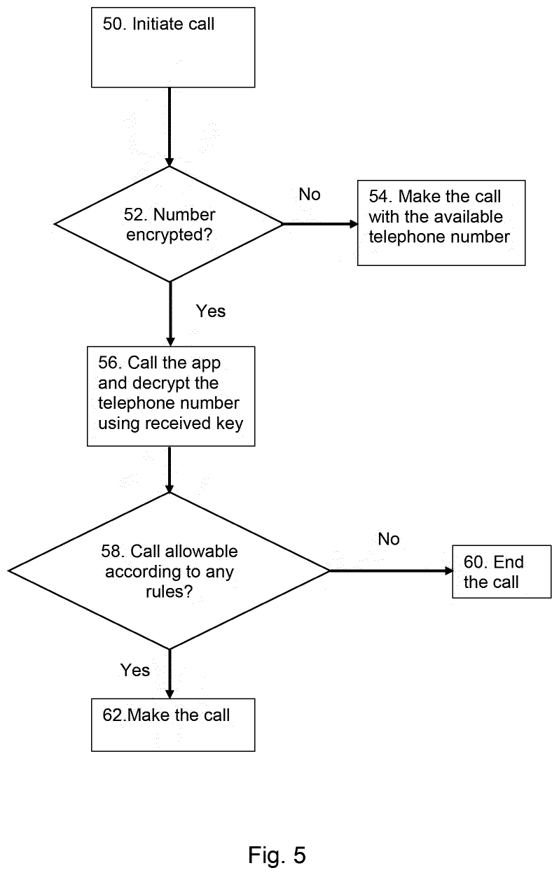

Referring to FIG. 5, this shows an example of the second telephone device 10″ using the number of the first telephone device 10′. In this example, the second telephone device 10″ is being used to call the first telephone device 10′, but in other examples the second telephone device 10″ may be being used to send a text (SMS or short message service) or other message via some other arrangement to the first telephone device 10′, or to make some other use of the number of the first telephone device 10′.

At 50, the user operates the second telephone device 10″ to initiate a call to the first telephone device 10′. The user may for example open a “phone book” or “contacts” function of the second telephone device 10″ and scroll through or search for the user of the first telephone device 10′. The user in such a case may then be presented by the second telephone device 10″ with a display like that shown in FIG. 4.

At 52, the second telephone device 10″ looks up the telephone number of the first telephone device 10′ as saved to the non-volatile memory 14 of the second telephone device 10″, and checks whether the telephone number has been saved in plain text form or encrypted form.

If the telephone number has been saved in plain text form, then at 54 the second telephone device 10″ can use the telephone number directly to make a call to the first telephone device 10′.

On the other hand, if the telephone number has been saved in encrypted form, then, at 56, the second telephone device 10″ opens the necessary software or “app” to decrypt the encrypted telephone number using the key that was previously obtained from the first telephone device 10′ and saved to the non-volatile memory 14 along with the encrypted telephone number.

At 58, if rules associated with the telephone number of the first telephone device 10′ were saved at the second telephone device 10″, then the rules are checked to see whether it is permitted to make a call at this time. Examples of such rules were discussed above.

At 60, if the rules indicate that a call is not permitted at the present time, then the attempt to make the call is ended. Otherwise, if the rules indicate that a call is permitted at the present time, or there are no (relevant) rules, then the call is made at 62.

For additional security, the first telephone device 10′ may generate a different key each time it is to encrypt its telephone number and send the encrypted telephone number and the key to another telephone device. That is, each other telephone device receives its own, unique key and, correspondingly, unique encrypted version of the telephone number of the first telephone device.

In examples described herein, a telephone number for a telephone device is transferred to another telephone device in encrypted form so that a user of the other telephone device cannot see that telephone number. A decryption key is transferred along with the encrypted telephone number so that the telephone number can be decrypted by the other telephone device. The other telephone device is arranged so that it does not display the telephone number in pain text format.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A method of transferring a telephone number of a first telephone device from the first telephone device to a second telephone device and storing the telephone number at the second telephone device, the method comprising:
at the first telephone device, creating a key for symmetric-key cryptography;
at the first telephone device, encrypting the telephone number of the first telephone device using symmetric-key cryptography and the key, thereby generating an encrypted version of the telephone number of the first telephone device;
transferring the key and the encrypted version of the telephone number of the first telephone device to the second telephone device;
at the second telephone device, saving the key to memory; and
at the second telephone device, saving to memory at least one of (i) the encrypted version of the telephone number of the first telephone device and (ii) a decrypted plain text version of the telephone number of the first telephone device obtained by decrypting the encrypted version of the telephone number using the key;
wherein the second telephone device is arranged such that a plain text version of the telephone number of the first telephone device is not displayed by the second telephone device.

2. A method according to claim 1, wherein the key and the encrypted version of the telephone number of the first telephone device are transferred to the second telephone device by the second telephone device reading a visual representation of the key and the encrypted version of the telephone number which is displayed by the first telephone device.

3. A method according to claim 1, wherein the key and the encrypted version of the telephone number of the first telephone device are transferred to the second telephone device by the first telephone device wirelessly transmitting the key and the encrypted version of the telephone number to the second telephone device.

4. A method according to claim 1, wherein in the case that the second telephone device is used to call the first telephone device, the second telephone device:
retrieves the telephone number of the first telephone device from the memory of the second telephone device;
decrypts the telephone number of the first telephone device using the key if the telephone number of the first telephone device is saved as an encrypted version;
initiates an outgoing call to the first telephone device using the telephone number; and
displays on a display screen of the second telephone device an identifier of the first telephone device and an obfuscated version of the telephone number of the first telephone device.

5. A method according to claim 1, comprising transferring from the first telephone device to the second telephone device rules which define permitted use of the telephone number by the second telephone device, wherein the second telephone device saves the rules to memory and consults the rules and acts in accordance with the rules as necessary when a user of the second telephone device attempts to use the telephone number of the first telephone device.

6. A method of operating a first telephone device to enable transfer of a telephone number of the first telephone device from the first telephone device to a second telephone device, the method comprising:
creating a key for symmetric-key cryptography;
encrypting the telephone number of the first telephone device using symmetric-key cryptography and the key, thereby generating an encrypted version of the telephone number of the first telephone device; and
making the key and the encrypted version of the telephone number of the first telephone device available to the second telephone device.

7. A method according to claim 6, wherein the key and the encrypted version of the telephone number of the first telephone device are made available to the second telephone device by the first telephone device displaying a visual representation of the key and the encrypted version of the telephone number which can be read by the second telephone device.

8. A method according to claim 6, wherein the key and the encrypted version of the telephone number of the first telephone device are made available to the second telephone device by the first telephone device wirelessly transmitting the key and the encrypted version of the telephone number to the second telephone device.

9. A method according to claim 6, comprising the first telephone device transferring to the second telephone device rules which define permitted use of the telephone number by the second telephone device.

10. A method of operating a second telephone device to obtain a telephone number of a first telephone device from the first telephone device, the method comprising:
receiving from the first telephone device an encrypted version of the telephone number of the first telephone device and an encryption key that was used by the first telephone device to encrypt the telephone number using symmetric-key cryptography;
saving the key to memory of the second telephone device; and
saving to memory of the second telephone device at least one of (i) the encrypted version of the telephone number of the first telephone device and (ii) a decrypted plain text version of the telephone number of the first telephone device obtained by decrypting the encrypted version of the telephone number using the key;
wherein the second telephone device is arranged such that a plain text version of the telephone number of the first telephone device is not displayed by the second telephone device.

11. A method according to claim 10, wherein the key and the encrypted version of the telephone number of the first telephone device are received from the first telephone device by the second telephone device reading a visual representation of the key and the encrypted version of the telephone number which is displayed by the first telephone device.

12. A method according to claim 10, wherein the key and the encrypted version of the telephone number of the first telephone device are received from the first telephone device by the first telephone device wirelessly transmitting the key and the encrypted version of the telephone number to the second telephone device.

13. A method according to claim 10, wherein in the case that the second telephone device is used to call the first telephone device, the second telephone device:
retrieves the telephone number of the first telephone device from the memory of the second telephone device;
decrypts the telephone number of the first telephone device using the key if the telephone number of the first telephone device is saved as an encrypted version;
initiates an outgoing call to the first telephone device using the telephone number; and
displays on a display screen of the second telephone device an identifier of the first telephone device and an obfuscated version of the telephone number of the first telephone device.

14. A telephone device constructed and arranged to carry out a method according to claim 6.

15. A computer program comprising instructions such that when the computer program is executed on a telephone device, the telephone device is arranged to carry out a method according to claim 6.

16. A telephone device constructed and arranged to carry out a method according to claim 10.

17. A computer program comprising instructions such that when the computer program is executed on a telephone device, the telephone device is arranged to carry out a method according to claim 10.
